(19) United States
(12) Patent Application Publication
(10) Pub. No.: US 2009/0271877 A1
(43) Pub. Date: Oct. 29, 2009

(54) METHOD TO SECURE EMBEDDED SYSTEM WITH PROGRAMMABLE LOGIC, HARDWARE AND SOFTWARE BINDING, EXECUTION MONITORING AND COUNTERACTION

(75) Inventor: Paul Bradley, Cumberland, RI (US)

Correspondence Address: PEARSON & PEARSON, LLP, 10 GEORGE STREET, LOWELL, MA, 01852, US

(73) Assignee: DAFCA, INC.

(21) Appl. No.: 12/407,537

(22) Filed: Mar. 19, 2009

Related U.S. Application Data
(60) Provisional application No. 61/048,306, filed on Apr. 28, 2008.

(51) Int. Cl. G06F 7/04; G06F 11/00

(52) U.S. Cl. 726/33; 726/26; 726/34

(57) ABSTRACT

Systems and methods for securing an embedded system are disclosed. An embedded system comprises a hardware subsystem including physical components of the embedded system, a software subsystem including a software application and a program code, and a programmable logic subsystem programmed to monitor one or more parts of the hardware and software subsystems and interactions thereof to detect tampering of the embedded system. The programmable logic subsystem is capable of being activated by a security function in the software subsystem or by a special hardware component in the hardware subsystem. The activation of the programmable logic subsystem facilitate a coupling of the hardware, software, and the programmable logic subsystems. The program code can be used to dynamically re-program the programmable logic subsystem.

### BACKGROUND

1. Technical Field

The present teaching relates generally to methods and systems for security against tampering. More specifically, the present teaching relates to methods and systems for securing an embedded system against tampering.

2. Background of the Disclosure

An embedded system may be a single semiconductor device, an FPGA or ASIC that contains processors and corresponding software instruction, or a printed circuit board assembly containing multiple FPGAs and/or ASICs, discrete or embedded processors as well as additional hardware circuitry. With the advances made in computing, more and more complex systems are being constructed within smaller and smaller physical devices. Such physical changes have enormous impact on security as private or proprietary information is entered, stored, received, and transmitted by such small computing devices. Therefore, designers and manufactures of such embedded systems must take measures to secure the system itself to prevent intellectual property or proprietary data contained therein or transferred through the embedded system from being compromised.

There are different methods for securing such systems, including but not limited to encryption and obfuscation of both the hardware and software components and information transfers in-between. However, the incremental cost for securing such systems often limits the extent to which such measures can be implemented. Reasons for such limitations include that embedded systems are often utilized within applications such as cellular phones, personal digital assistants (PDA), and portable media players where low cost is of primary concern.

The cost for implementing security measures in an embedded system often makes it financially infeasible to deliver embedded systems solutions that are desired in the market place. Moreover the economics of hardware security methods are further complicated by the fact that once a hardware system is compromised, it is usually cost prohibitive to patch or upgrade the hardware. Without effective counteracting measures, the underlying embedded systems remain vulnerable.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a functional layer view of an embedded system, according to an embodiment of the present teaching;

FIG. 2 depicts exemplary relationships between hardware/software subsystems and a programmable logic subsystem in an embedded system constructed in accordance with the present teaching;

FIG. 3 illustrates an exemplary construct of a programmable logic subsystem, according to an embodiment of the present teaching;

FIG. 4(a) illustrates an exemplary implementation of a logic which can be programmed to elect one or more particular security functions based on a program code, according to an embodiment of the present teaching;

FIG. 4(b) illustrates an exemplary security function that is capable of reacting to a detected hazard condition by controlling an output signal, according to an embodiment of the present teaching;

FIG. 5 is a flow diagram of an exemplary process of creating a secure embedded system, according to an embodiment of the present teaching;

FIG. 6 depicts an exemplary mechanism to activate a programmable logic subsystem from a software subsystem, according to an embodiment of the present teaching;

FIG. 7 illustrates an exemplary sequence of events within a secure embedded system where a security measure is activated via software means, according to an embodiment of the present teaching;

FIG. 8 depicts an alternative exemplary mechanism to activate a programmable logic subsystem via hardware means, according to an embodiment of the present teaching; and

FIG. 9 depicts an exemplary hardware subsystem with an optional trigger therein, according to an embodiment of the present teaching.

### DETAILED DESCRIPTION

The present teaching relates to security measures to improve hardware and software assurance against tampering in an embedded system. The present teaching discloses systems comprising custom hardware devices such as FPGAs and ASICs, processors and software that runs on one or more processors and interacts with other circuitry within an embedded system. The security systems and methods disclosed herein bind hardware and software systems with obfuscation to make it harder for the embedded system to be compromised. In addition, the disclosed systems and methods are capable of reacting to a detected security breach to prevent harm potentially imposed on the embedded system. Because the disclosed security systems and methods are highly configurable, programmable, and can be dynamically re-programmed in a manner specific to each and every individual device, they provide a higher level of protection than any prior art systems.

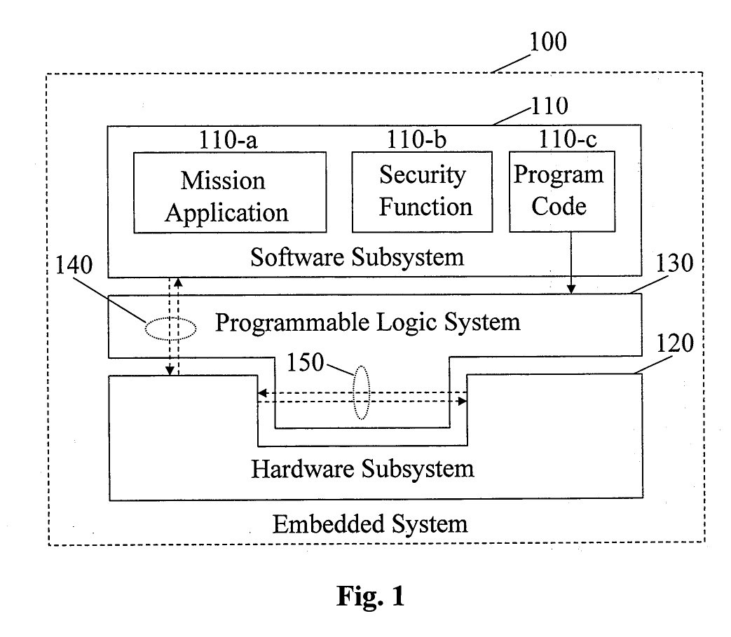

FIG. 1 is a functional layer view of an embedded system 100, according to an embodiment of the present teaching. As shown, the embedded system 100 comprises a software subsystem 110, a hardware subsystem 120, and a programmable logic subsystem 130. The programmable logic subsystem 130 is a part of the hardware subsystem 120 (indicated by the portion of the programmable logic subsystem indented within the hardware subsystem 120.).

The software subsystem contains a mission application 110-a, security function 110-b, and program codes 110-c. The mission code is a set of software instructions being executed on the hardware subsystem 120 defining the overall functions for the embedded system 100. The security function 110-b is a set of software instructions being executed on the hardware subsystem 120 to secure the embedded system 100. The program codes 110-c define or program the functions to be performed by the programmable logic subsystem 130.

The programmable logic subsystem 130 binds the hardware subsystem 120 and the software subsystem 110 and operates to provide security protection for the software and hardware subsystems against tampering. The programmable logic subsystem 130 can not only detect tampering but also react to such detected security hazards to prevent harm from being done to the embedded system 100. In some embodiments, the programmable logic subsystem 130 is capable of, as shown at 140, observing, analyzing, or even controlling (modifying) information exchanged between the hardware subsystem 110 and software subsystem 120. In addition, the programmable logic subsystem 130 may be capable of observing, analyzing, or controlling (modifying) information exchanged between different hardware components, such as DMA transfers, state machine transitions, etc. This is shown at 150 in FIG. 1.

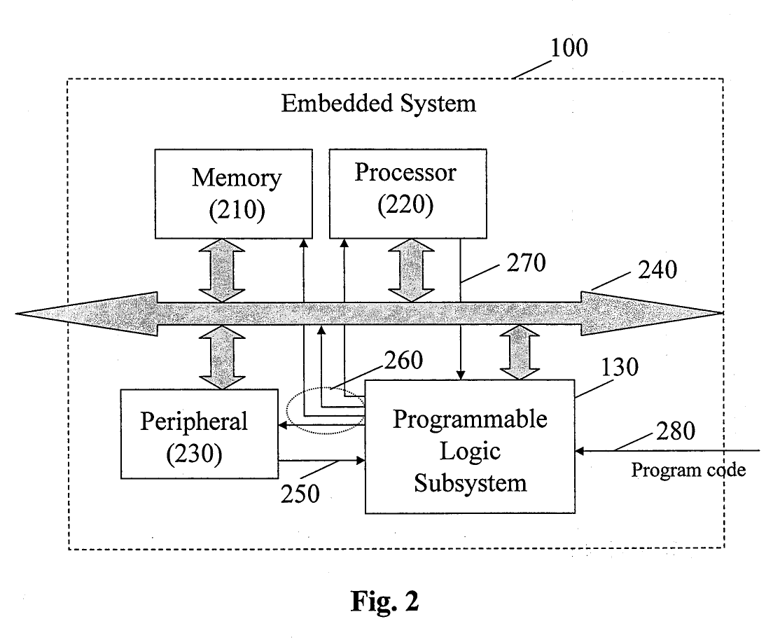

FIG. 2 depicts exemplary construct involving the hardware/software subsystems 120 and 110 and the programmable logic subsystem 130 in an embedded system implemented in accordance with the present teaching. In the illustrated embodiment, the hardware subsystem 110 comprises a memory 210, a processor 220, and peripherals 230. To facilitate communication among these hardware components, the hardware subsystem 110 also comprises an information exchange interface 240. The software subsystem 120 corresponds to code that is stored in a storage device such as either the memory 210 or the peripheral 230, e.g., a flash card and executed by the processor 220. As seen, the hardware subsystem 120 corresponds to the physical system components, whereas the software subsystem corresponds to the software stored and executed by the embedded system 100.

The programmable logic subsystem 130 is a system that can be configured flexibly to connect or tap into any parts of the hardware subsystem. For instance, the programmable logic subsystem can be configured to tap into an arbitrarily distributed set of components in the hardware subsystem 120. Based on specific application needs, the programmable logic subsystem 130 can be configured differently to monitor different parts of the hardware subsystem 120. For example, the programmable logic subsystem 130 can be configured to observe various types of information in and out of different hardware components such as information 260 flowing through the information exchange interface (240) and information 250 among different peripherals of the embedded system 100.

The programmable logic subsystem can also be configured to monitor different hardware components including memory 210, processor 220, as well as the peripheral (230). Such configured connectivity allows the programmable logic subsystem 130 to track and analyze signals observed at configured locations in the embedded system for the purposes of identifying correct and incorrect embedded system behavior.

In some embodiments, the programmable logic subsystem 130 is capable of being configured to perform concurrent tasks, e.g., making multiple observations, performing a plurality of analysis, and carrying out different control functions, all at the same time, with respect to, e.g., the same or different system components. For example, the programmable logic subsystem 130 can be configured to operate on multiple information exchange interfaces concurrently while performing different functions on one or more of such interfaces.

The process to configure the programmable logic subsystem is to determine, at least in part, the locations in the hardware with respect to which security functions are to be performed. As discussed above, the flexibility in the configuration of the programmable logic subsystem 130 to monitor anywhere in the hardware system makes the security measure practically ubiquitous and capable of being application dependent. Another characteristic of the disclosed security method is that, in addition to being configurable, the functions that the programmable logic subsystem 130 perform in operation to counter the tampering activities can also be programmed or re-programmed, making the security measure dynamic and harder to compromise.

The programmed functions, which potentially can be dynamic, are to be executed by the programmable logic subsystem 130 in order to monitor various locations configured to be monitored. Since the specific functions programmed to be executed to detect tampering may change over time, this characteristic makes the embedded system 100 more secure, thus, making the security protection of the embedded system 100 more obfuscated and difficult to tamper.

According to the present teaching, the programmable logic subsystem 130 can be programmed via program codes. In some embodiments, as shown in FIG. 2, the programmable logic subsystem 130 can be programmed based on internally supplied program codes 270. In some embodiments, the programmable logic subsystem 130 can be programmed based on externally supplied program codes 280. Each of the program codes 270 or 280 may correspond to one or more program codes. Each of the program code may program a portion of the programmable logic subsystem 130.

Whenever the program codes (either 270 or 280) are input to the programmable logic subsystem, the programmable logic subsystem is re-programmed. The re-programming can occur at any point in time, so that the security function performed by the programmable logic subsystem can be changed dynamically (“on-the-fly”). The programmable logic subsystem comprises programmable logic structures that do not, in and of themselves, indicate the functions that they can perform. Their functionality is obfuscated due to the programmable nature/structure. Such structure and programmable characteristics can be found in U.S. Pat. No. 7,058,918, entitled “Reconfigurable Fabric For SOCs Using Functional I/O Leads”, assigned to DAFCA, Inc. According to the disclosure therein, a programmable logic system can include a core and a wrapper, where the wrapper may reconfigure the core based on some event occurred.

Therefore, the programmable logic subsystem 130 is a highly customized collection or fabric of discrete programmable components, which can be assembled in a unique fashion for each embedded system design. Such a programmable logic can be implemented as a core or a wrapper, as detailed in the above referenced patent. The unique and customized nature of the programmable logic subsystem can be defined by the embedded system designer.

In addition, the programmable logic subsystem can be programmed in part or wholly, depending on the program codes that are input to the programmable logic subsystem. The program codes may be chosen based on different requirements of specific security functions desired. Furthermore, in some embodiments, the programmable logic subsystem 130 can be programmed to perform a unique function on each individual embedded system manufactured. For instance, each embedded system may optionally contain a unique ID (a key) that, together with the program codes, may define a specific set of programmable logic subsystem functions that is unique for that particular embedded system manufactured.

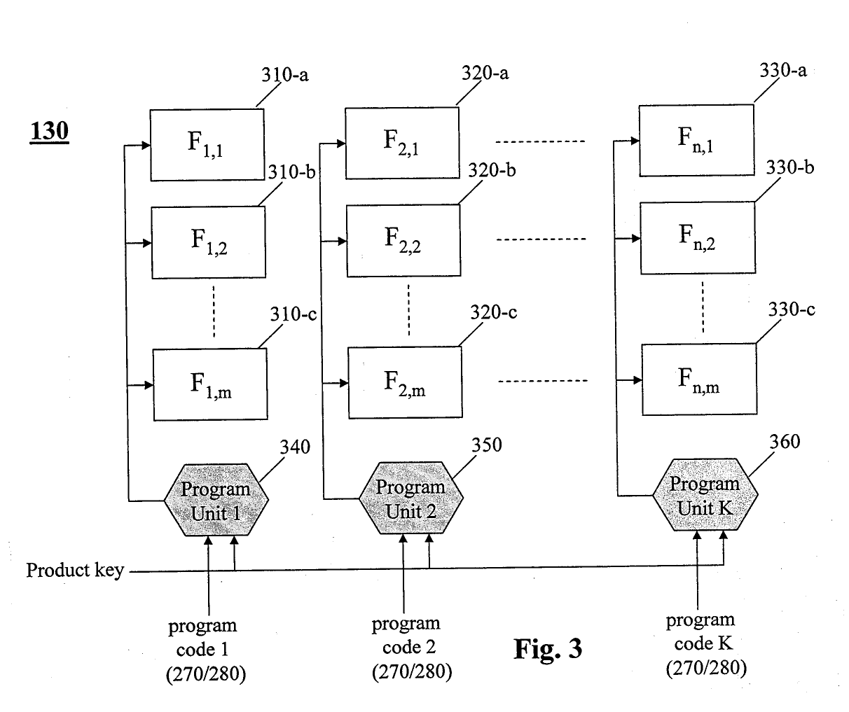

FIG. 3 illustrates an exemplary construct of the programmable logic subsystem 130, according to an embodiment of the present teaching. In general, the programmable logic subsystem 130 is a collection of basic units of logic circuits that can connect with each other via a programmable means. The programmable logic subsystem can be implemented as a combination of centralized and distributed programmable resources and function as a wrapper. The balance of distributed and centralized logic can be made specific to each application and determined by each designer. In FIG. 3, there are multiple groups of logic 310, 320, . . . , 330, each of which can be programmed to perform one or more of a plurality of functions. For instance, logic 310 may be programmed to perform one or more of functions 310-a, 310-b, . . . , and 310-c. Logic 320 may be programmed to perform one or more of functions 320-a, 320-b, . . . , 320-c. Logic 330 may be programmed to perform one or more of functions 330-a, 330-b, and 330-c, etc. The programming of each group of logic is achieved via their corresponding programming circuitry 340, 350, . . . , and 360. Circuit 340 takes a program code 1 as input and, optionally, a product key of the underlying embedded system, as program codes and selectively elects one or more functions within the group as security functions. Whenever the program code 1 is changed, the elected functions are also re-programmed. In addition, whenever there is a different product key, the programmed functions will also be changed even when the same program code 1 is supplied. Similar characteristics apply to other logic groups 320, . . . , 330.

This provides protection against a multitude of devices being compromised subsequent to a single device being compromised. For example, a hacker may identify a means to compromise a single device by substituting a portion of software code within the mission application. Such intrusion will not affect another devices because this second system will be protected by a different set of security measures (monitors for example), which likely will detect the intrusion and take countermeasures.

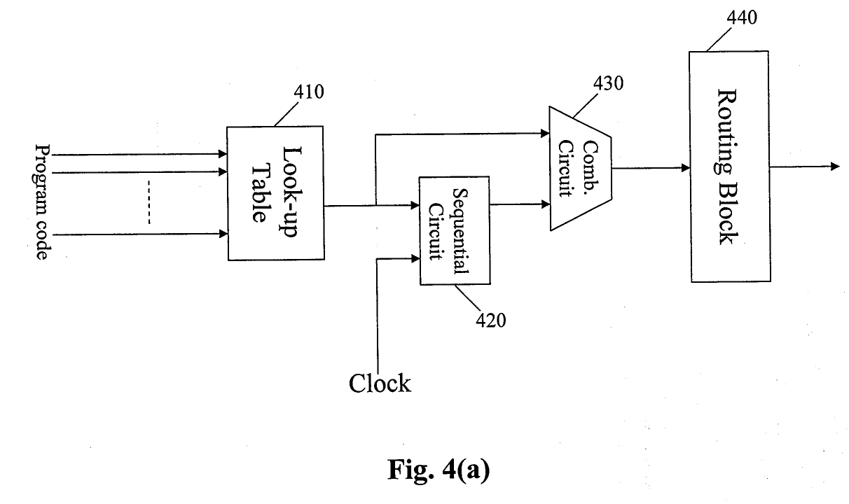

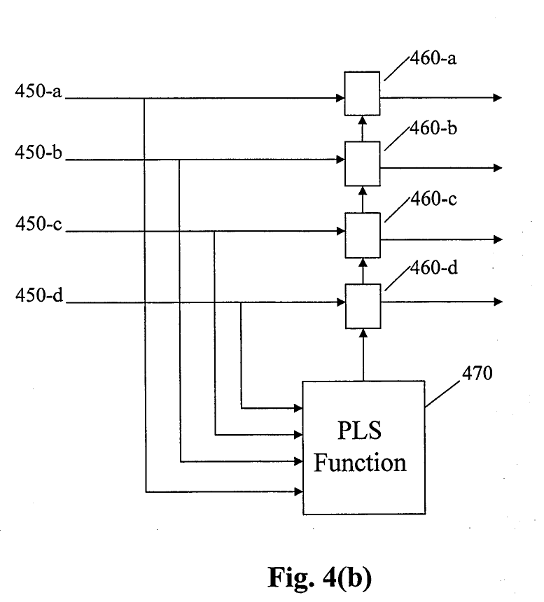

FIG. 4(a) illustrates an exemplary implementation of a logic which can be programmed to select a particular security function based on a program code, according to an embodiment of the present teaching. Program codes are supplied to a look-up table 410 and the output of the look-up table 410 controls the selection of either a sequential circuit 420 or a combinatory circuit 430 being selected to output signals to a routing block 440.

In some embodiments, the programmable logic system 130 can control certain hardware component or various signals (logic) connected to or within the hardware or peripheral components. Such control functions allow the programmable logic subsystem 130 to react to incorrect system behavior detected in the embedded system 100 and to counteract security breaches. For example, the programmable logic subsystem 130 may react to a detected security breach by electing to, e.g., shutdown a component or system, obfuscate a signal or transaction, or initiate a software exception, etc.

FIG. 4(b) illustrates an exemplary security function that is capable of reacting to a detected hazard condition by controlling the output signal, according to an embodiment of the present teaching. There are a plurality of signals 450-a, 450-b, 450-c, and 450-d connecting to the input terminals of the corresponding hardware gates 460-a, 460-b, 460-c, and 460-d. There is a programmable logic subsystem that performs a PLS function 470. The PLS function 470 taps the four input signals 450-a, . . . , 450-d and whenever a certain condition is detected, e.g., when all inputs correspond to zero, the PLS function 470 reacts to the detected condition by sending a control signal to the hardware components 460-a, . . . , 460-d to, e.g., force these components to produce a certain output. The PLS function 470 may be designed to detect an abnormal condition and then react to control the behavior of the hardware components to prevent potential harm caused by the abnormality.

As seen herein, the overall security measures provided to the embedded system 100 comprise the security function(s) 110-b performed by the software subsystem 110 as well as the security functions programmed in the programmable logic subsystem 130. Since the security functions performed by the programmable logic subsystem 130 can be programmed via program codes, the overall security or hardware/software assurance provided to the embedded system 100 is therefore also programmable. As the program code can be dynamically downloaded by the software subsystem or externally input to the programmable logic subsystem, this provides additional protection to the embedded system against tampering.

As illustrated in FIG. 3, multiple system security functions can be made operational at the same time. As discussed herein, such system security functions may span both software and hardware subsystems, thus binding the two systems and making it more difficult to tamper with either system without being detected. In some embodiments, one or more security functions can be executed before the mission code starts to be executed so that the performance of the mission code is minimally affected by the security function during run time. In addition, as the programmable logic subsystem 130 can be programmed through an externally provided program code, e.g., via an auxiliary port, this provides a means for another system to optionally inject program codes from outside of the embedded system to enable certain security functions. This makes the embedded system capable of being protected further because it does not have to rely on the software subsystem, which can be compromised in some situations, to determine the security function to be performed (via a program code that the software subsystem downloads) to protect the embedded system.

As described, the overall system security functions can be customized and made unique. In addition, the designer of the embedded system is not the only one who can define the security functions; the subsequent users may also dynamically determine the security measure for the system. Below, different embodiments for implementing the disclosed security methods and systems are described. It is understood that such described embodiments are for illustration only and they are not limitations to the present teaching.

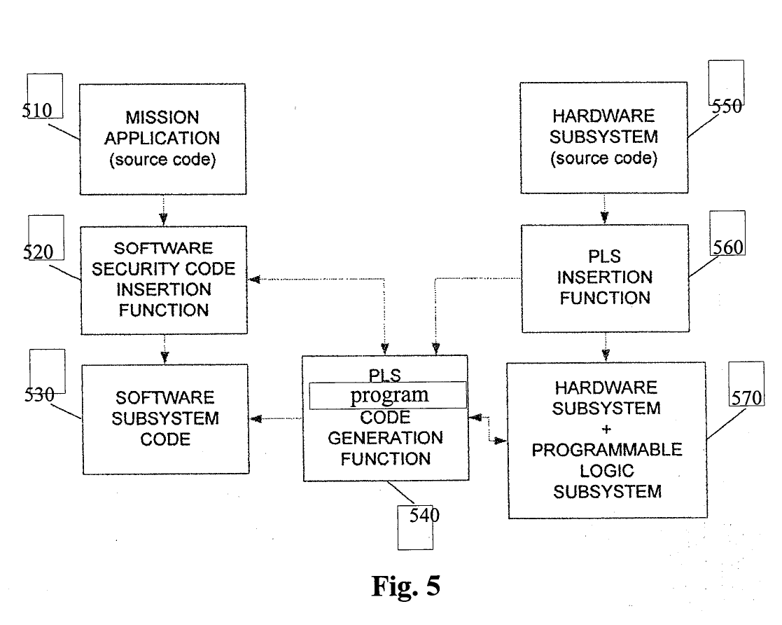

The embedded system 100 with the disclosed security system and method incorporated therein can be realized in different ways. FIG. 5 is a flow diagram of an exemplary process of creating the secure embedded system 100, according to an embodiment of the present teaching. There is a plurality of steps to create the embedded system 100. In the left portion in FIG. 5, it comprises steps of 510, 520, 530, and 540, corresponding to the process of generating the software subsystem 110. In the right portion in FIG. 5, it comprises steps 550 and 560, corresponding to the process of generating the hardware subsystem 120 as well as the step 560 of configuring the programmable logic subsystem 130 with the hardware, via, e.g., verilog or RTL codes.

As can be seen, the software subsystem code (530) is produced via a process where the original mission application (510) is subjected to the software security code insertion (at 520) which is to interact with the programmable logic program code generation function (540) to determine how to program the security function(s) to be performed by the programmable logic subsystem. The hardware subsystem and programmable logic subsystem are created via a process in which the original hardware source code (550), e.g., verilog or RTL code, is subjected to a programmable logic insertion function (560). The programmable program code generation function (540) is informed by the programmable logic insertion function (560) regarding the nature of the customized and unique structures inserted into the system. The PLS program code generation function (540) used can be, e.g., the Clearblue Silicon Validation Studio (CSVS), available from DAFCA, Inc., Natick Mass., U.S.A. The functions that can be performed by the programmable logic subsystem 130 can be user defined via 540. The security functions carried out by the software subsystem 110 can be defined by a user at step 520.

In some embodiments, the security function carried out by the software subsystem 110 can be implemented so that the programmable logic subsystem monitors the mission application instruction address space to ensure some predetermined address locations between the pre-defined start and end address. In some embodiments, when a watchdog timer tick interrupt is generated by a hardware peripheral with the hardware subsystem, the programmable logic subsystem initiates a checksum calculation on an instruction code located in a pre-defined address space. The expected checksum may be stored within the program code. Multiple instruction codes may be designed to sniff different address locations and the sniffed information may be analyzed over a period of time (multiple timer ticks).

Other exemplary implementations are also possible. For example, within a critical application thread in a known instruction address space, a specified set of address locations are read or written at specified intervals. The read and write values, sequences and latencies relating to the address space in use may be monitored by the programmable logic subsystem 130 to ensure that certain patterns are maintained. As another exemplary embodiment, a pseudo-random value may be written within a body of mission application code, into a register of the programmable logic subsystem. The programmable logic subsystem may then calculate a return value based on the input value and return an expected value to the software. The return value may be designed as a function of the program code loaded into the programmable logic subsystem, which can be changed dynamically. For example, different program codes can be loaded on odd and even days to introduce some dynamically changing security measures. Such dynamic programmable logic program code may call for a calculated return value to be a function of the present date—meaning its value will change dynamically based on a variable unknown to the ordinary user. When an incorrect return value is encountered, the software subsystem may then react to the situation, e.g., throw an exception or halt the operation.

The disclosed security system and method enable important and useful characteristics. For example, the disclosed approach provides multiple layers of obfuscation and obstruction against tampering. A customized programmable logic subsystem can not only detect abnormality but can also react to the abnormality to protect the embedded system. The security measure put in place to protect the embedded system in terms of hardware/software assurance can be updated or upgraded at any time based on needs to proactively or reactively address new security threats. The programmable logic subsystem is not a static IP block but a fabric overlaying the hardware subsystem. The fact that the RTL form or gate-level netlist form of the programmable logic subsystem function is not defined or represents an un-programmed resource makes it much harder to be compromised. Furthermore, since the programmable logic subsystem is used in conjunction with the software security function, which prevents the software image from being lifted from the embedded system, there are multiple layers of protection against a security breach.

The reason that those characteristics make an embedded system more difficult to compromise is that an intruder has to discover and reverse engineer a multitude of complex hardware and software systems and interactions thereof. For example, the software security scheme provides a benefit to an embedded system because it protects the embedded system by periodically loading a program code that can be used to re-program the programmable logic subsystem and, hence, dynamically alter the security measure used for the security check. For example, the areas to be checked may be changed. The method used to check such targeted areas may also be dynamically changed. In order for an intruder attempting to compromise the mission application code through additions, subtractions, or replacements, one will likely need to overcome whatever dynamic software protection mechanisms that are put in place, which would make it very difficult. For example, in order to break into the embedded system without being detected, an intruder has to discover and comprehend the code of the security function that is responsible for loading the program code(s), discover and comprehend the meaning and function of the loaded program codes with respect to the programmable hardware subsystem, which further requires the intruder to discover and comprehend the hardware structures of the programmable hardware subsystem. To the extent that an intruder attempts to compromise such a system through trial and error, they must overcome the apparent pseudo-randomness of detection and actual intrusion detection. The intruder will also have to overcome the countermeasures, which can include dynamic alternating security measures, various countermeasures that are already operational such as complete or partial shutdown, additional obfuscation methods and increasingly aggressive security functions through the activation of addition program codes, either internally or externally.

Variations and exemplary implementations of the disclosed security system and method include also the means to activate the programmable logic subsystem while the embedded system is in operation. In some embodiments, the programmable logic subsystem 130 can be configured to be automatically activated when the embedded system 100 is in operation. In some embodiments, the programmable logic subsystem 130 may be triggered, via some kind of mechanism, in order to be operational. Different exemplary embodiments to activate the programmable logic subsystem are described below. They are merely exemplary and not limiting.

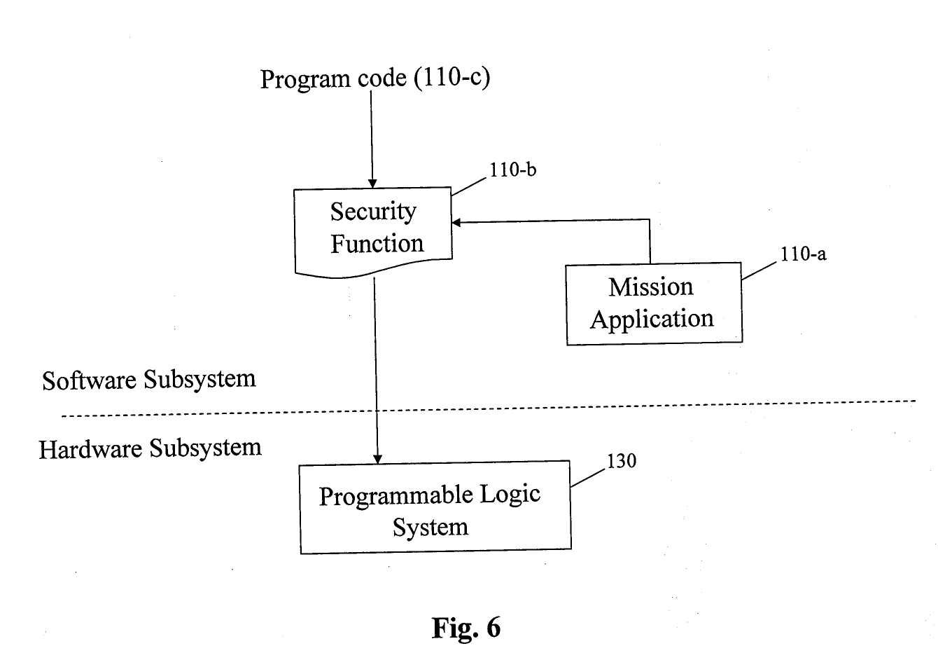

In some embodiments, the programmable logic subsystem 130 can be triggered by the software subsystem 120 when the security function 110-b of the software subsystem 110 is executed. FIG. 6 depicts an exemplary mechanism to activate a programmable logic subsystem from a software subsystem, according to an embodiment of the present teaching. In the software subsystem, the security function 110-b, when operative, will perform certain functions to protect the embedded system. Among those functions, it may download the program code 110-c and then use the downloaded program code to program the programmable logic system 130, which becomes a part of the security measure of the entire system.

The security function 110-b can be made operative in different ways. For example, when the mission application 110-a is executed, since the security function 110-b may be a part of the software code (inserted into the mission application code), the security function can be executed during the process. In some embodiments, the security function may be made operative independently. For example, the security function may be activated upon being uploaded and being executed prior to the execution of the mission application.

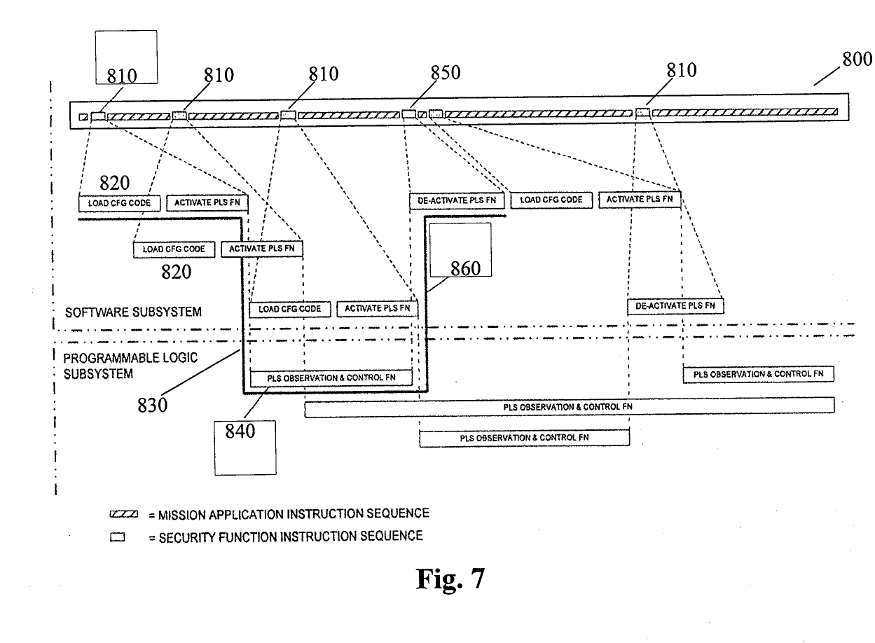

FIG. 7 illustrates an exemplary sequence of events within a secure embedded system when security measure is activated via software means, according to an embodiment of the present teaching. This figure illustrates the execution relationship between the software subsystem (top portion in FIG. 7) and overall system security functions, which is a combination of the security function 810 of the software subsystem and the programmable logic subsystem (the lower portion in FIG. 7). When the software subsystem is loaded and made operational, a sequence of instructions, including the security function 810, may be distributed through insertion in the mission application code. When instructions from the security function are executed, they may load program codes from some pre-determined sources at 820. The loaded program code may subsequently be used, as shown in FIG. 7, to program and activate programmed functions at 830 in the programmable logic subsystem. Upon being programmed and activated, the programmable logic subsystem, which resides in the hardware subsystem (the lower portion in FIG. 7), starts to function at 840 as programmed, e.g., making observations, detecting security breaches, exercising control, if programmed so, to react to a detected security breach.

In some embodiments, the security function 810 may be inserted into the mission application code in a distributed manner, as illustrated in FIG. 7. In this case, any piece of distributed security function code may contain instructions for downloading a program code and for programming the programmable logic subsystem for additional security functions to be performed by the programmable logic subsystem. In this way, the software subsystem is capable of activating a plurality of security measures at different times of software execution by downloading and programming the programmable logic system at different times so that security measures are implemented at different locations of the embedded system and at different times. This is shown in FIG. 7.

In some embodiments, the security function inserted in the mission application may also contain instructions that, when executed, serve to deactivate some specific functions that have been previously programmed to operate in the programmable logic subsystem. For instance, a piece of security function shown as 850 in FIG. 7, acts, when executed, to deactivate a particular function within the programmable logic subsystem (in the hardware) and stop the operation of such previously activated function, as shown at 860.

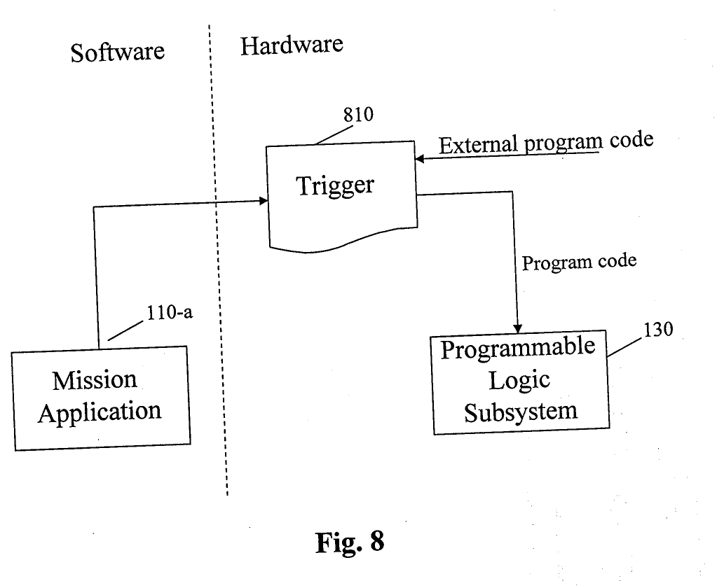

FIG. 8 depicts an alternative exemplary mechanism to activate a programmable logic subsystem via hardware means, according to an embodiment of the present teaching. In FIG. 8, the hardware subsystem (the right portion in FIG. 8) includes a trigger 810, which is used to trigger the programmable logic subsystem 130. The trigger 810 can be self-activating or can be activated based on some event. For example, whenever the mission application is loaded or starts to run, such an event can be used to activate the trigger 810. In this exemplary operational mode, once activated, the trigger 810 may retrieve one or more program codes from some pre-determined source and then use the retrieved program code to program and activate the programmable logic subsystem 130.

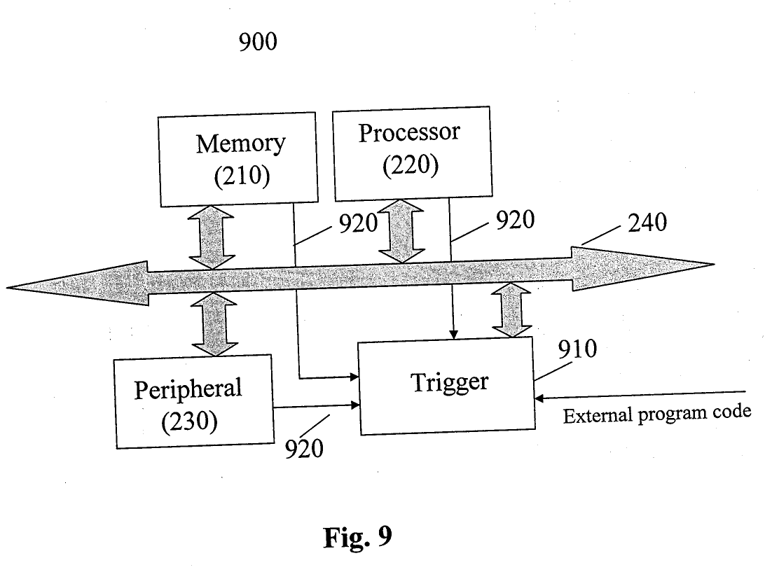

The trigger 810 may also be activated via other means. In some embodiments, the trigger 810 may be activated by an externally entered program code. In some embodiments, the trigger 810 can be self-activating in an automated mode. For example, whenever the embedded system is powered on, the trigger 810 may activate itself and then retrieve program codes from a pre-determined storage, e.g., memory or removable memory, and program the programmable logic subsystem. Under such a hardware activation scheme, the hardware subsystem may optionally incorporate a special purpose component as the trigger. This is shown in FIG. 9 where the trigger component 910 is a part of the hardware subsystem and it may connect to any other hardware component, such as processor 220, memory 210, or peripheral 230, to receive program codes to be used to program and activate the programmable logic subsystem (not shown). Alternatively, the trigger 910 may also be designed to be able to receive program codes externally.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the inventions have been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

We claim:

1. An embedded system, comprising:
a hardware subsystem configured to include physical components of the embedded system;
a software subsystem comprising a software application, a security function, and a program code;
a programmable logic subsystem capable of being programmed to monitor one or more parts of the hardware and software subsystems and interactions thereof to detect tampering of the embedded system, wherein
the security function is capable of activating the programmable logic subsystem to facilitate a coupling of the hardware, software, and the programmable logic subsystems, and
the program code is capable of dynamically re-programming the programmable logic subsystem.

2. The system according to claim 1, wherein the programmable logic subsystem is further capable of being programmed to interface with the hardware and software subsystems to detect tampering of the embedded system.

3. The system according to claim 1, wherein the programmable logic subsystem is further capable of reacting to the detection of the tampering of the embedded system.

4. The system according to claim 1, wherein the programmable logic subsystem comprises a core and a wrapper.

5. The system according to claim 4, wherein the wrapper is capable of re-programming the core upon a occurrence of an event.

6. The system according to claim 5, wherein the event includes the detection of the tampering of the embedded system.

7. The system according to claim 3, wherein said reacting to the detection of tampering includes reprogramming the programmable logic subsystem to perform a function different from a previous function performed by the programmable logic subsystem prior to the detection of the tampering.

8. The system according to claim 3, wherein said reacting to the detection of tampering includes disabling one or more parts of the hardware subsystem.

9. The system according to claim 3, wherein said reacting to the detection of tampering includes bypassing one or more parts of the hardware subsystem.

10. The system according to claim 3, wherein said reacting to the detection of tampering includes disabling one or more parts of the software subsystem.

11. The system according to claim 3, wherein said reacting to the detection of tampering includes bypassing one or more parts of the software subsystem.

12. The system according to claim 3, wherein said reacting to the detection of tampering includes activating a different part of code in the software subsystem.

13. The system according to claim 3, wherein said reacting to the detection of tampering includes activating a different part of the hardware subsystem.

14. The system according to claim 1, wherein the programmable logic subsystem is further capable of interacting with at least one of the hardware subsystem and the software subsystem.

15. The system according to claim 14, wherein said interacting includes:
receiving first information from the at least one of the hardware and software subsystems;
generating a response based on the received first information; and
sending the response to the at least one of the hardware and software subsystems.

16. The system according to claim 15, wherein said interacting further includes:
receiving second information;
reprogramming the programmable logic subsystem in accordance with the second information.

17. An embedded system, comprising:
a hardware subsystem configured to comprise physical components of the embedded system including a specialized hardware component;
a software subsystem comprising a software application and a program code;
a programmable logic subsystem capable of being programmed to monitor one or more parts of the hardware and software subsystems and interactions thereof to secure the embedded system against tampering, wherein
the specialized hardware component, upon being triggered, activates the programmable logic subsystem to facilitate a coupling of the hardware, software, and the programmable logic subsystems, and
the program code is capable of dynamically re-programming the programmable logic subsystem.

18. The system according to claim 17, wherein the programmable logic subsystem is further capable of being programmed to interface with the hardware and software subsystems to secure the embedded system against tampering.

19. The system according to claim 17, wherein the programmable logic subsystem is further capable of reacting to the detection of the tampering of the embedded system.

20. The system according to claim 17, wherein the programmable logic subsystem comprises a core and a wrapper.

21. The system according to claim 20, wherein the wrapper is capable of re-programming the core upon a occurrence of an event.

22. The system according to claim 21, wherein the event includes the detection of the tampering of the embedded system.

23. The system according to claim 17, wherein the programmable logic subsystem is further capable of interacting with at least one of the hardware subsystem and the software subsystem.

24. A method for constructing an embedded system, comprising:
inserting a security function into a software application, forming a part of a software subsystem;
constructing a hardware subsystem comprising physical components of the embedded system and circuitries of a programmable logic subsystem, wherein
the programmable logic subsystem is capable of being programmed to monitor one or more parts of the hardware and software subsystems and interactions thereof to secure the embedded system against tampering,
the security function activates the programmable logic subsystem to facilitate a coupling of the hardware, software, and the programmable logic subsystems, and
the software subsystem further includes a program code that is capable of dynamically re-programming the programmable logic subsystem.

25. The method according to claim 24, wherein the programmable logic subsystem is further capable of being programmed to interface with the hardware and software subsystems to secure the embedded system against tampering.

26. The method according to claim 24, wherein the programmable logic subsystem is further capable of reacting to the detection of the tampering of the embedded system.

27. The system according to claim 24, wherein the programmable logic subsystem is further capable of interacting with at least one of the hardware subsystem and the software subsystem.

28. A method for constructing an embedded system, comprising:
implementing a software application, which is a part of a software subsystem;
implementing a hardware subsystem having physical components of the embedded system, circuitries of a programmable logic subsystem, and a specialized hardware component, wherein
the programmable logic subsystem is capable of being programmed to monitor one or more parts of the hardware and software subsystems and interactions thereof to secure the embedded system against tampering,
the specialized hardware component, once triggered, activates the programmable logic subsystem to facilitate a coupling of the hardware, software, and the programmable logic subsystems, and
the software subsystem further includes a program code that is capable of dynamically re-programming the programmable logic subsystem.

29. The method according to claim 28, wherein the programmable logic subsystem is further capable of being configured to interface with the hardware and software subsystems to secure the embedded system against tampering.

30. The method according to claim 28, wherein the programmable logic subsystem is further capable of reacting to the detection of the tampering of the embedded system.

31. The system according to claim 28, wherein the programmable logic subsystem is further capable of interacting with at least one of the hardware subsystem and the software subsystem.
